(19) United States
(12) Patent Application Publication
(10) Pub. No.: US 2023/0017905 A1
(43) Pub. Date: Jan. 19, 2023

(54) SPECTROSCOPIC CAMERA

(71) Applicant: SEIKO EPSON CORPORATION, TOKYO (JP)

(72) Inventor: Daisuke SAITO, Matsumoto-shi (JP)

(21) Appl. No.: 17/813,101

(22) Filed: Jul. 18, 2022

(30) Foreign Application Priority Data
Jul. 16, 2021 (JP) 2021-117682

(51) Int. Cl. G01J 3/28; G01J 3/02; G01J 3/12

(52) U.S. Cl. CPC G01J 3/2823; G01J 3/0202; G01J 3/0208; G01J 3/0291; G01J 3/12; G01J 2003/2826; G01J 2003/1221

(57) ABSTRACT

A spectroscopic camera includes: a spectral filter having an optical area that transmits light with a predetermined wavelength from incident light; an image sensor receiving transmitted light transmitted through the spectral filter; and a casing accommodating the spectral filter and the image sensor. A direction in which the incident light enters is a first direction. The casing includes: a cylindrical lens mount which a lens that the incident light enters is attachable to and removable from and which has a center axis along the first direction; a wall having an aperture that has an aperture center coaxial with the center axis of the lens mount and that is smaller than a cylindrical inner diameter of the lens mount and equal to or smaller than an outer diameter of the optical area; a filter accommodation unit accommodating the spectral filter at such a position that the optical area covers the aperture, as viewed in a plan view along the first direction; and an imaging sensor accommodation unit provided downstream of the filter accommodation unit in the first direction and accommodating the image sensor at such a position that the image sensor overlaps the aperture as viewed in the plan view.

The present application is based on, and claims priority from JP Application Serial Number 2021-117682, filed Jul. 16, 2021, the disclosure of which is hereby incorporated by reference herein in its entirety.

### BACKGROUND

### 1. Technical Field

The present disclosure relates to a spectroscopic camera.

### 2. Related Art

According to the related art, a spectroscopic camera that spectrally separates light with a predetermined wavelength from light entering from an image pickup target and picks up an image of the spectrally separated light to acquire a spectral image is known. JP-A-2017-201317 is an example of the related art.

In the spectroscopic camera described in JP-A-2017-201317, image light entering from an objective lens is guided to a Fabry-Perot filter and the light transmitted through the Fabry-Perot filter is received by a sensor array. In this spectroscopic camera, blocks formed by a plurality of filters transmitting light in different wavelength ranges from each other are arranged in the form of an array in the Fabry-Perot filter and sensors in the sensor array are arranged corresponding to the individual filters.

In the spectroscopic camera described in JP-A-2017-201317, the Fabry-Perot filter and the sensor array are unified together. Filters corresponding to a plurality of wavelengths are provided in the Fabry-Perot filter. The sensors in the sensor array correspond one-to-one to the individual filters. In the spectroscopic camera with such a configuration, a plurality of sensors corresponding to a plurality of wavelengths need to be arranged to one pixel in the spectral image. Therefore, a problem arises when the picked-up spectral image has a low resolution. To cope with this problem, a variable-wavelength Fabry-Perot etalon may be used. In this case, one sensor can correspond to one pixel in the spectral image and the spectral image can be picked up with a high resolution.

However, in the spectroscopic camera as described above, the light spectrally separated by the spectral filter such as the Fabry-Perot etalon element needs to properly enter the image sensor such as the sensor array. For example, in a general camera that picks up a color image, the optical axes of a lens installed at a lens mount in a camera casing and an image sensor accommodated in the camera casing are aligned together. Meanwhile, in the spectroscopic camera, the optical axis of the spectral filter needs to be properly aligned in addition to the lens and the image sensor. This poses a problem in that the process relating to the optical axis alignment is complex. Particularly, when a variable-wavelength Fabry-Perot filter is used, due to the structure thereof, each filter cannot be formed in the size of each pixel in the image sensor, as in JP-A-2017-201317. Therefore, the image sensor and the spectral filter need to be spaced apart from each other and an optical system that causes the light spectrally separated by the spectral filter to form an image on the image sensor needs to be provided separately. In this case, there is a problem in that the process relating to the alignment adjustment as described above is even more complex.

### SUMMARY

An object of the present disclosure is to provide a spectroscopic camera with a simple structure that can adjust the positions of a lens installed at a lens mount, a spectral filter, and an image sensor.

According to an aspect of the present disclosure, a spectroscopic camera includes: a spectral filter having an optical area that transmits light with a predetermined wavelength from incident light; an image sensor receiving transmitted light transmitted through the spectral filter; and a casing accommodating the spectral filter and the image sensor. A direction in which the incident light enters is a first direction. The casing includes: a cylindrical lens mount which a lens that the incident light enters is attachable to and removable from and which has a center axis along the first direction; a wall having an aperture; a filter accommodation unit accommodating the spectral filter at such a position that the optical area covers the aperture, as viewed in a plan view along the first direction; and an imaging sensor accommodation unit provided downstream of the filter accommodation unit in the first direction and accommodating the image sensor at such a position that the image sensor overlaps the aperture as viewed in the plan view. The aperture has an aperture center coaxial with the center axis of the lens mount and is smaller than a cylindrical inner diameter of the lens mount and equal to or smaller than an outer diameter of the optical area.

In the spectroscopic camera according to this aspect, the wall may be provided between the lens mount and the filter accommodation unit.

In the spectroscopic camera according to this aspect, the filter accommodation unit may be provided next to the wall in the first direction and the spectral filter may be in contact with the wall.

In the spectroscopic camera according to this aspect, the spectral filter may have a pair of reflective films arranged via a gap in the first direction, and a gap changing section changing a length of the gap. The optical area may be a region where the pair of reflective films overlap each other as viewed in the plan view.

### BRIEF DESCRIPTION OF THE DRAWINGS

FIG. 1 is a cross-sectional view showing a schematic configuration of a spectroscopic camera according to an embodiment of the present disclosure.

FIG. 2 is an exploded perspective view of the spectroscopic camera according to the embodiment.

FIG. 3 is a schematic cross-sectional view showing a spectral filter in the embodiment.

FIG. 4 explains an alignment adjustment method for the spectroscopic camera according to the embodiment.

### DESCRIPTION OF EXEMPLARY EMBODIMENTS

An embodiment of the present disclosure will now be described.

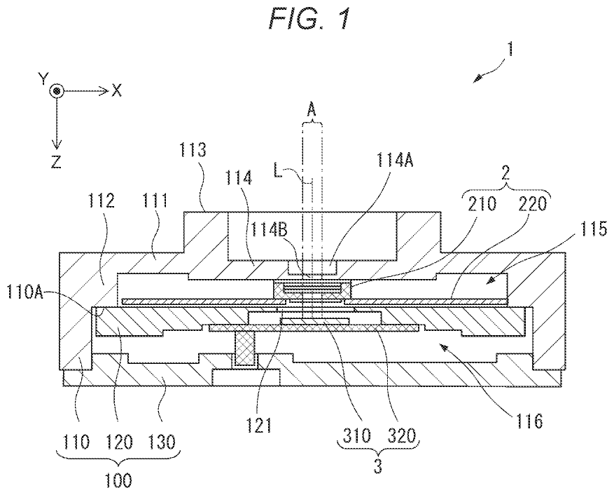

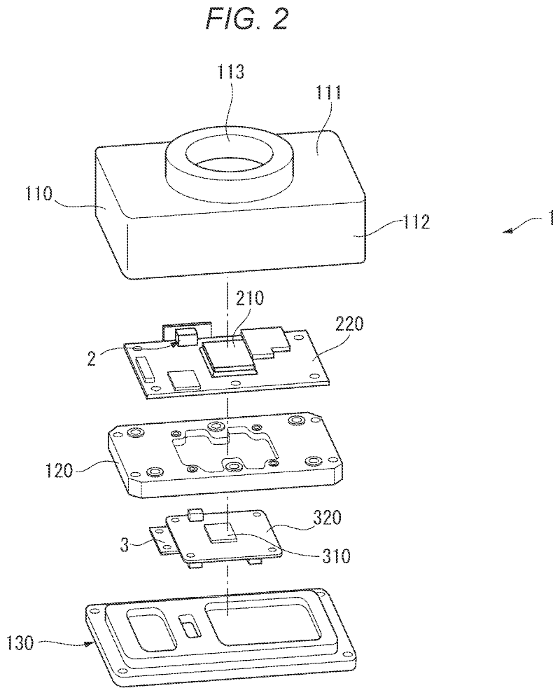

FIG. 1 is a cross-sectional view showing a schematic configuration of a spectroscopic camera 1 according to this embodiment. FIG. 2 is an exploded perspective view of the spectroscopic camera 1 shown in FIG. 1.

The spectroscopic camera 1 according to the embodiment can be installed, for example, in a portable terminal device such as a smartphone, a small flying object such as a drone, or the like.

As shown in FIG. 1, the spectroscopic camera 1 has a filter unit 2, an image pickup unit 3, and a casing 100 accommodating the filter unit 2 and the image pickup unit 3. A lens unit, not illustrated, is attachable to and removable from the casing 100. In the spectroscopic camera 1, incident light entering via the lens unit is guided to a spectral filter 210 provided in the filter unit 2. An image sensor 310 provided in the image pickup unit 3 picks up an image of light with a predetermined wavelength spectrally separated by the spectral filter 210. Thus, the spectroscopic camera 1 can pick up a spectral image with the predetermined wavelength of an image pickup target.

A direction in which the incident light from the image pickup target enters when the spectroscopic camera 1 picks up an image of the image pickup target is a first direction according to the present disclosure. Hereinafter, the first direction is referred to as a Z-direction. One direction orthogonal to the Z-direction is referred to as an X-direction. A direction orthogonal to the Z-direction and the X-direction is referred to as a Y-direction.

The configuration of each part of such a spectroscopic camera 1 will now be described in detail.

Schematic Configuration of Filter Unit 2

The filter unit 2 has the spectral filter 210 and a filter substrate 220 where the spectral filter 210 is installed.

The spectral filter 210 is a filter having an optical area that spectrally separates light with a predetermined wavelength from incident light entering along the Z-direction. In this embodiment, a variable-wavelength Fabry-Perot etalon is employed as the spectral filter 210.

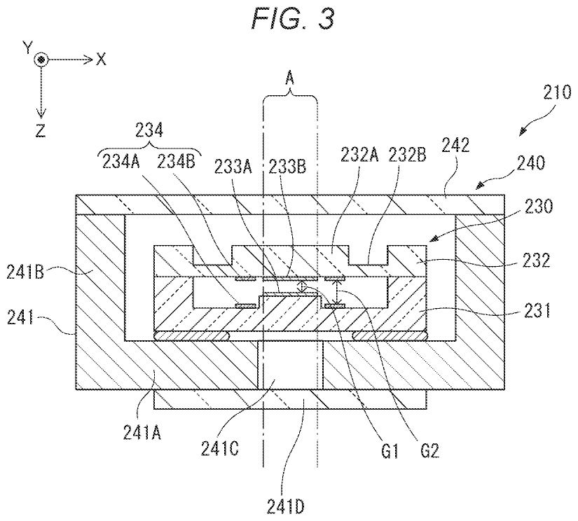

FIG. 3 is a schematic cross-sectional view of the spectral filter 210 in this embodiment.

As shown in FIG. 3, the spectral filter 210 has a spectral filter main body 230 and a package unit 240.

The spectral filter main body 230 is made up of a first substrate 231, a second substrate 232, a first reflective film 233A, a second reflective film 233B, and an electrostatic actuator 234.

The first substrate 231 and the second substrate 232 are substrates that are light-transmissive to the wavelength of the spectral image picked up by the spectroscopic camera 1, that is, the spectral wavelength spectrally separated by the spectral filter 210. For example, when picking up a spectral image with a predetermined wavelength in the visible light range, the spectral filter 210 spectrally separates and transmits the light with the predetermined wavelength in the visible light range from incident light. In this case, the first substrate 231 and the second substrate 232 may be formed by a substrate that can transmit visible light such as a quartz crystal substrate. Meanwhile, when picking up a spectral image with a predetermined wavelength in the near-infrared range, the spectral filter 210 spectrally separates and transmits light with the predetermined wavelength in the near-infrared range from incident light. Therefore, the first substrate 231 and the second substrate 232 may be formed by a substrate that can transmit near-infrared light such as a silicon substrate.

At a surface of the first substrate 231 that faces the second substrate 232, a first electrode 234A forming the first reflective film 233A and the electrostatic actuator 234 is provided.

At a surface of the second substrate 232 that faces the first substrate 231, a second electrode 234B forming the second reflective film 233B and the electrostatic actuator 234 is provided.

Also, a recess is formed, for example, by etching or the like at the surface of the first substrate 231 that faces the second substrate 232. Thus, the first reflective film 233A and the second reflective film 233B face each other via a predetermined first gap G1, and the first electrode 234A and the second electrode 234B face each other via a predetermined second gap G2.

Meanwhile, at the surface of the second substrate 232 on the side opposite to the first substrate 231, for example, an annular recess is formed and a moving part 232A at the center of the substrate and a diaphragm 232B holding the moving part 232A are thus formed. The second reflective film 233B is provided at a surface of the moving part 232A that faces the first substrate 231. The second electrode 234B may be provided at the moving part 232A or at the diaphragm 232B or may be provided over an area from the moving part 232A to the diaphragm 232B.

In the spectral filter main body 230 of such a configuration, the electrostatic actuator 234 functions as a gap changing section according to the present disclosure. When a voltage is applied to the electrostatic actuator 234, the electrostatic actuator 234 flexes the diaphragm 232B by electrostatic attraction and displaces the moving part 232A in the Z-direction. Thus, the dimension of the first gap G1 between the first reflective film 233A and the second reflective film 233B changes and the wavelength of the light transmitted through the spectral filter main body 230 changes. As the thickness of the moving part 232A is greater than the thickness of the diaphragm 232B, the flexure of the moving part 232A, that is, the flexure of the second reflective film 233B, is restrained.

A region where the first reflective film 233A and the second reflective film 233B of the spectral filter main body 230 overlap each other, when the spectral filter 210 in this embodiment is viewed along the Z-direction, is an optical area A according to the present disclosure.

The package unit 240 is a box-like casing with an internal space maintained in a reduced-pressure environment and accommodates the spectral filter main body 230 inside.

The package unit 240 has a base 241 and a lid 242, for example, as shown in FIG. 3. The base 241 and the lid 242 are joined together, thus forming an accommodation space inside.

The base 241 is formed, for example, of a ceramic or the like and has a pedestal part 241A and a sidewall 241B.

The pedestal part 241A is formed, for example, in the shape of a flat plate having a rectangular outer shape along an XY plane orthogonal to the Z-direction. The cylindrical sidewall 241B rises up toward the lid 242 from an outer circumferential part of the pedestal part 241A.

The pedestal part 241A has an opening 241C penetrating the pedestal part 241A along the Z-direction. The opening 241C overlaps the optical area A, as viewed in a plan view from the Z-direction, in the state where the spectral filter main body 230 is accommodated in the package unit 240.

A glass substrate 241D covering the opening 241C is joined to the surface of the pedestal part 241A on the side opposite to the lid 242.

At the inner surface of the pedestal part 241A that faces the lid 242, a wiring part, not illustrated, that is coupled to the first electrode 234A and the second electrode 234B of the spectral filter main body 230, is provided. The wiring part is coupled to an external terminal unit, not illustrated, at the outer surface of the pedestal part 241A via a through-silicon via and is coupled to a circuit unit, not illustrated, provided at the filter substrate 220 via the external terminal.

The sidewall 241B is formed in the shape of a frame rising up from an edge part of the pedestal part 241A. The end surface of the sidewall 241B on the side opposite to the pedestal part 241A is a planar surface orthogonal to the Z-direction and the lid 242 is joined to this end surface. The lid 242 is, for example, a transparent member having a rectangular outer shape as viewed in a plan view and is formed of glass or the like, for example.

The spectral filter main body 230 is fixed, for example, to the pedestal part 241A and the sidewall 241B of the base 241, for example, with an adhesive.

The filter substrate 220 is a substrate where the package unit 240 is fixed.

In the filter substrate 220, a penetration hole along the Z-direction is provided at a position overlapping the optical area A, as viewed in a plan view from the Z-direction. Thus, the light spectrally separated by the spectral filter main body 230 passes through the penetration hole and is received by the image sensor 310 provided in the image pickup unit 3. A spectral image is thus picked up.

Although not illustrated, a circuit unit coupled to the external terminal unit provided in the package unit 240 is provided at the filter substrate 220. In the circuit unit, various circuits controlling the spectral filter main body 230 are provided. The various circuits may include, for example, a microcomputer computing a voltage applied to the electrostatic actuator 234 of the spectral filter main body 230 and a voltage control circuit applying the voltage to the electrostatic actuator 234 in response to a command from the microcomputer, or the like.

Specifically, the microcomputer has, for example, a storage unit such as a memory and stores drive data for controlling the electrostatic actuator 234. The drive data may be, for example, V-A data that records the drive voltage in relation to the spectral wavelength transmitted through the spectral filter main body 230, or the like. When a capacitance detection electrode detecting the electrostatic capacitance of the first reflective film 233A and the second reflective film 233B is provided in the spectral filter main body 230, C-A data that records the electrostatic capacitance in relation to the spectral wavelength, or the like, may be stored. The microcomputer outputs the drive voltage corresponding to the target spectral wavelength to the voltage control circuit, for example, based on a command from the image pickup unit 3.

The voltage control circuit applies the drive voltage to the electrostatic actuator 234, based on a command inputted from the microcomputer. When a capacitance detection electrode detecting the electrostatic capacitance of the first reflective film 233A and the second reflective film 233B is provided in the spectral filter main body 230, the voltage control circuit may perform feedback control on the voltage applied to the electrostatic actuator 234, based on the detected electrostatic capacitance.

### Configuration of Image Pickup Unit 3

The image pickup unit 3 has the image sensor 310 and an image pickup substrate 320 where the image sensor 310 is fixed.

The image sensor 310 is a sensor array and is a term including a CCD (charge-coupled device), a CMOS (complementary metal-oxide semiconductor) or the like, for example. The image sensor 310 receives incident light and output a received light signal corresponding to each pixel region (each sensor). In this embodiment, a light-receiving surface of the image sensor 310 overlaps the optical area A, as viewed from the Z-direction, and the optical area A is included within the light-receiving surface.

The image pickup substrate 320 has a control circuit unit electrically coupled to the image sensor 310. The control circuit unit has, for example, a storage circuit such as a memory and a computing circuit such as a CPU. The control circuit unit controls the operation of the image sensor 310 and thus generates image information. The image pickup substrate 320 is communicatively coupled to the filter substrate 220 and gives a command about a target spectral wavelength to the filter substrate 220. Thus, the microcomputer provided at the filter substrate 220 controls the spectral filter 210 and light with the target wavelength is transmitted through the spectral filter 210.

### Configuration of Casing 100

The casing 100 includes a closed-bottom cylindrical main body part 110, a board stage 120, and a lid part 130 or the like. The main body part 110 is in the shape of a container open to the +Z side, for example. The main body part 110 and the lid part 130 together form an accommodation space accommodating the filter unit 2, the board stage 120, and the image pickup unit 3.

The main body part 110 is a closed-bottom cylindrical member having a planar front part 111 and a side part 112 rising up to the +Z side from the outer circumference of the front part 111. As the opening opposite to the front part 111 is closed by the lid part 130, the main body part 110 forms a closed space inside.

At the front part 111, a lens mount 113 extending to the −Z side is provided.

The lens mount 113 is a part which a lens is attachable to and removable from, and is configured in conformity with a predetermined lens mount standard. For example, in this embodiment, the lens mount 113 has a C-mount lens replacement standard and is formed in a cylindrical shape with which a C-mount lens can be spirally fitted. The cylindrical center axis of the lens mount 113 serves as the optical axis of the lens mounted on the lens mount 113.

A wall 114 is provided to the +Z side of the lens mount 113. A cylindrical recess 114A coaxial with the lens mount 113 is provided in the wall 114. An aperture 114B is provided at a bottom surface (surface on the +Z side) of the recess 114A.

The recess 114A is formed with a diameter dimension that secures an angle of field of view for image light entering via the lens mounted on the lens mount 113.

The aperture 114B has an aperture center coaxial with the lens mount 113 and the recess 114A. The inner diameter of the aperture 114B is formed to be smaller than the cylindrical inner diameter of the lens mount 113 and the recess 114A and equal to or smaller than the outer diameter of the optical area A in the spectral filter 210, that is, the region where the first reflective film 233A and the second reflective film 233B overlap each other in the Z-direction.

A filter accommodation unit 115 is provided to the +Z side of the wall 114.

For example, in this embodiment, a step part 110A that can hold the board stage 120 is provided at an inner circumferential surface of the main body part 110, and the board stage 120 is fixed to the step part 110A. Thus, the space surrounded by the front part 111, the side part 112, the wall 114, and the board stage 120 forms the filter accommodation unit 115.

The board stage 120 is formed in the shape of a flat plate. The filter unit 2 with the spectral filter 210 installed therein is fixed to a surface on the −Z side of the board stage 120. A penetration hole 121 through which the light transmitted through the optical area A passes is formed in the board stage 120. The opening size of the penetration hole 121 may be greater than the outer diameter of the optical area A.

As the board stage 120 is placed at the step part 110A, the filter unit 2 is accommodated in the filter accommodation unit 115. The outer shape of the board stage 120 along an XY plane orthogonal to the Z-direction is smaller than the shape of the inner circumferential surface of the side part 112. Therefore, the board stage 120 is movable within a predetermined allowable distance range in the XY-directions on the step part 110A. Thus, the position of the spectral filter 210 can be finely adjusted to the position where the optical area A overlaps the aperture 114B.

As the board stage 120 is fixed to the step part 110A, the lid 242 of the spectral filter 210 comes in contact with the wall 114. Thus, stray light can be restrained from entering the spectral filter 210.

The side part 112 on the +Z side of the main body part 110, the board stage 120, and the lid part 130 together form an imaging sensor accommodation unit 116. The image pickup unit 3 is accommodated in the imaging sensor accommodation unit 116. Specifically, as the image pickup substrate 320 is fixed to the board stage 120 at the position where the light-receiving surface of the image sensor 310 overlaps the optical area A, the image pickup unit 3 is accommodated in the imaging sensor accommodation unit 116.

Although not illustrated, another optical component may be arranged on the optical path of the incident light. For example, a band-pass filter may be provided at the opening side of the aperture 114B on the lens mount 113 side, or between the aperture 114B and the spectral filter 210, or between the spectral filter 210 and the image sensor 310.

### Fixing Filter Unit 2 and Image Pickup Unit 3 to Casing 100

In the spectroscopic camera 1 as described above, the alignment of the lens mount 113, the aperture 114B, the spectral filter 210, and the image sensor 310 can be easily adjusted, based on the position of the aperture 114B.

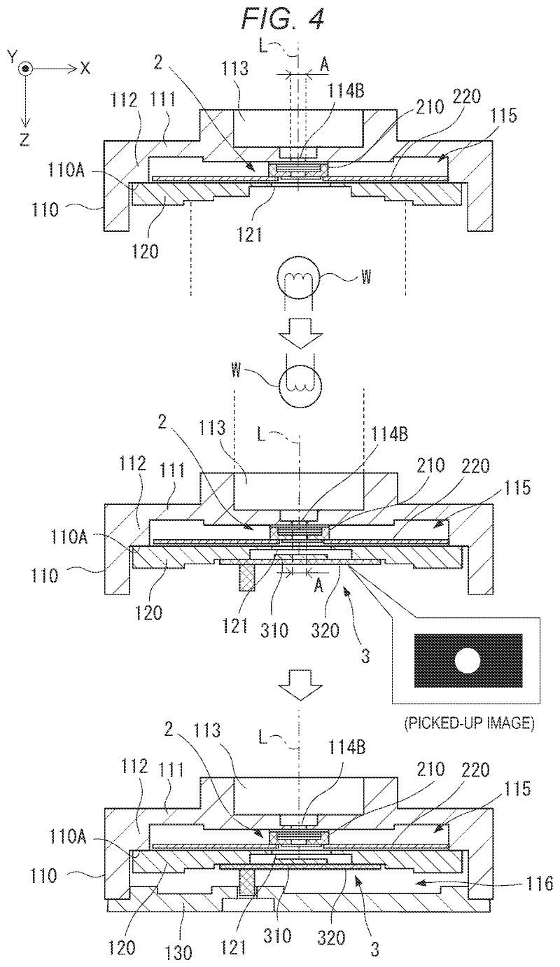

FIG. 4 explains an alignment adjustment method.

In the alignment adjustment in the spectroscopic camera 1, first, the filter unit 2 is fixed to the board stage 120. At this point, the filter unit 2 is fixed to the board stage 120 in such a way that the optical area A is included in the penetration hole 121 when viewed from the direction from the first reflective film 233A toward the second reflective film 233B, that is, from the Z-direction.

Next, as shown in the first illustration of FIG. 4, the board stage 120 is placed into the main body part 110 of the casing 100. Also, white light is cast from a white light source W from the +Z side toward the −Z side and the light passing through the aperture 114B is observed from the lens mount 113 side.

The position of the spectral filter 210, that is, the position of the board stage 120, is adjusted in such a way that light with a wavelength corresponding to the initial dimension of the first gap G1 is observed from the entire area of the aperture 114B. The board stage 120 is fixed in this state.

That is, when the position of the optical area A is misaligned with the aperture 114B, the light with the wavelength corresponding to the initial dimension of the first gap G1 is observed only in a part of the area of the aperture 114B. In the other parts of the area, the white light that has not passed through the optical area A is observed or the light is blocked by the package unit 240 or the like and therefore is not observed. Meanwhile, when the position of the optical area A is properly located in relation to the aperture 114B, the light with the wavelength corresponding to the initial dimension of the first gap G1 is observed from the entire area of the aperture 114B. Therefore, the position of the board stage 120 where the filter unit 2 including the spectral filter 210 is fixed is adjusted in such a way that the light with the wavelength corresponding to the initial dimension of the first gap G1 is observed from the entire area of the aperture 114B.

Next, as shown in the second illustration of FIG. 4, the image pickup unit 3 is placed into the main body part 110. Then, white light is cast from the white light source W from the −Z side toward the +Z side and an image of the light transmitted through the spectral filter 210 is picked up by the image sensor 310.

The position of the image pickup unit 3 is adjusted and fixed in such a way that the light with the wavelength corresponding to the dimension of the first gap G1, transmitted through the optical area A, is received by the light-receiving surface of the image sensor 310.

When the size of the light-receiving surface is sufficiently larger than the size of the optical area A, the position may be adjusted in such a way that the entirety of the optical area A is included in the light-receiving surface in the Z-direction.

Subsequently, as shown in the third illustration of FIG. 4, the lid part 130 is fixed to the main body part 110. The spectroscopic camera 1 is thus assembled.

### Advantageous Effects of Embodiment

The spectroscopic camera 1 according to this embodiment has the spectral filter 210, the image sensor 310, and the casing 100. The spectral filter 210 has the optical area A transmitting light with a predetermined wavelength from incident light. The image sensor 310 receives the transmitted light transmitted through the spectral filter 210. The casing 100 accommodates the image sensor 310 and the spectral filter 210. The casing 100 has the lens mount 113, the wall 114, the filter accommodation unit 115, and the imaging sensor accommodation unit 116. The lens mount 113 is formed in a cylindrical shape which a lens that the incident light enters is attachable to and removable from and which has a center axis L along the Z-direction. The wall 114 has the aperture 114B which has an aperture center coaxial with the center axis L of the lens mount 113 and which is small than the cylindrical diameter of the lens mount 113 and equal to or smaller than the outer diameter of the optical area A. The filter accommodation unit 115 accommodates the spectral filter 210 at the position where the optical area A covers the aperture 114B, as viewed in a plan view along the Z-direction. The imaging sensor accommodation unit 116 is provided downstream of the filter accommodation unit 115 in the Z-direction and accommodates the image sensor 310 at the position where the image sensor 310 overlaps the aperture 114B, as viewed in a plan view from the Z-direction.

In such a spectroscopic camera 1, the lens mount 113 and the aperture 114B are coaxial with each other. Therefore, by placing the spectral filter 210 into the casing 100, casting white light from the +Z side, and observing the cast light from the lens mount 113 side, one can check the position of the spectral filter 210 in relation to the aperture 114B. Subsequently, by placing the image sensor 310 into the casing 100, casting white light from the −Z side, and checking an image picked up by the image sensor 310, one can check the position of the image sensor 310 in relation to the aperture 114B.

As described above, in the spectroscopic camera 1 according to the embodiment, the position of the aperture 114B in relation to the lens mount 113 is fixed. Therefore, by adjusting the position of the spectral filter 210 in relation to the aperture 114B and the position of the image sensor 310 in relation to the aperture 114B, one can easily perform position adjustment, that is, optical axis alignment, between the lens mount 113, the aperture 114B, the spectral filter 210, and the image sensor 310. Each of the position adjustment between the aperture 114B and the spectral filter 210 and the position adjustment between the aperture 114B and the image sensor 310 is one-to-one position adjustment and is therefore easier than, for example, when the position adjustment between the aperture 114B, the spectral filter 210, and the image sensor 310 is performed at a time. Therefore, the process relating to the alignment adjustment can be simplified with a simple configuration.

In the spectroscopic camera 1 according to the embodiment, the wall 114 is provided between the lens mount 113 and the filter accommodation unit 115.

That is, the aperture 114B is provided upstream of the spectral filter 210 in the direction of incidence of incident light. Thus, stray light can be restrained from entering the spectral filter 210 and a drop in the spectral accuracy of the spectral filter 210 due to stray light can be restrained. That is, when stray light enters the spectral filter 210, the amount of light of the stray light component becomes a noise and a proper spectral image cannot be picked up. Particularly when a Fabry-Perot etalon where the first substrate 231 and the second substrate 232 are arranged facing each other is used as the spectral filter 210 as in this embodiment, there is a risk of the stray light component entering the optical area A on the image sensor 310 without being multiple-reflected between the first substrate 231 and the second substrate 232. In contrast, when the aperture 114B is provided upstream of the spectral filter 210, the influence of the noise due to the stray light component can be restrained and a spectral image with high accuracy can be picked up.

In the spectroscopic camera 1 according to the embodiment, the filter accommodation unit 115 is provided next to the wall 114 in the Z-direction and the spectral filter 210 is in contact with the wall 114.

Thus, the inconvenience of stray light entering from the gap between the spectral filter 210 and the wall 114 can be restrained and the spectroscopic camera 1 can pick up a spectral image with high accuracy.

In the spectroscopic camera 1 according to the embodiment, the spectral filter 210 has the pair of reflective films 233A, 233B arranged via the first gap G1 along the Z-direction, and the electrostatic actuator 234 as the gap changing section changing the length of the first gap G1. The optical area A is a region where the pair of reflective films 233A, 233B overlap each other, as viewed in a plan view from the Z-direction.

That is, in the embodiment, a variable-wavelength Fabry-Perot etalon is used as the spectral filter 210. Such a Fabry-Perot etalon can be reduced in thickness and can be suitably used in the spectroscopic camera 1 that can be installed in a potable terminal device, a small flying object or the like.

### Modification Examples

The present disclosure is not limited to the above embodiment and includes modifications, improvements, and the like within a scope that can achieve the object of the present disclosure.

For example, in the embodiment, the filter accommodation unit 115 is formed by the front part 111, the side part 112, and the wall 114 of the main body part 110, and the board stage 120. The filter substrate 220 is fixed to the board stage 120. The board stage 120 is fixed to the step part 110A. Thus, the spectral filter 210 is positioned at a predetermined position in the filter accommodation unit. However, a configuration where the filter substrate 220 is fixed directly to, for example, the step part 110A or the like of the main body part 110, may be employed.

The same applies to the imaging sensor accommodation unit 116. While an example where the imaging sensor accommodation unit 116 is formed by the side part 112, the board stage 120, and the lid part 130 and where the image pickup substrate 320 is fixed to the board stage 120 is described, this example is not limiting. For example, a configuration where the image pickup substrate 320 is fixed to the main body part 110 or the lid part 130 may be employed.

In the embodiment, a Fabry-Perot etalon where the first reflective film 233A and the second reflective film 233B face each other via the first gap G1 is employed as an example of the spectral filter 210. However, another spectral filter may be used. For example, an AOTF (acousto-optic tunable filter), an LCTF (liquid crystal tunable filter) or the like may be used as a spectral filter.

In the embodiment, the electrostatic actuator 234 having the first electrode 234A provided at the first substrate 231 and the second electrode 234B provided at the second substrate 232 is employed as an example of the gap changing section changing the first gap G1. However, this example is not limiting. For example, an actuator that displaces the moving part 232A by a magnetic force generated by a magnetic element provided at the first substrate 231 and a coil electrode provided at the second substrate 232 may be used as the gap changing section. The moving part 232A may also be displaced by another drive force. Also, while an example where the moving part 232A is displaced toward the first substrate 231 is described in the embodiment, a configuration where the moving part 232A is displaced in a direction away from the first substrate 231 may be employed.

In the embodiment, a configuration where the wall 114 having the aperture 114B is provided between the lens mount 113 and the spectral filter 210 is described. However, an aperture may also be provided between the spectral filter 210 and the image sensor 310. For example, the penetration hole 121 in the board stage 120 may be used as an aperture, or a flat plate member where an aperture is provided may be fixed to the board stage 120.

What is claimed is:

1. A spectroscopic camera comprising:
a spectral filter having an optical area that transmits light with a predetermined wavelength from incident light;
an image sensor receiving transmitted light transmitted through the spectral filter; and
a casing accommodating the spectral filter and the image sensor, wherein
a direction in which the incident light enters is a first direction,
the casing comprises:
a cylindrical lens mount which a lens that the incident light enters is attachable to and removable from and which has a center axis along the first direction;
a wall having an aperture;
a filter accommodation unit accommodating the spectral filter at such a position that the optical area covers the aperture, as viewed in a plan view along the first direction; and
an imaging sensor accommodation unit provided downstream of the filter accommodation unit in the first direction and accommodating the image sensor at such a position that the image sensor overlaps the aperture as viewed in the plan view, and
the aperture has an aperture center coaxial with the center axis of the lens mount and is smaller than a cylindrical inner diameter of the lens mount and equal to or smaller than an outer diameter of the optical area.

2. The spectroscopic camera according to claim 1, wherein
the wall is provided between the lens mount and the filter accommodation unit.

3. The spectroscopic camera according to claim 1, wherein
the filter accommodation unit is provided next to the wall in the first direction and the spectral filter is in contact with the wall.

4. The spectroscopic camera according to claim 1, wherein
the spectral filter has a pair of reflective films arranged via a gap in the first direction, and a gap changing section changing a length of the gap, and
the optical area is a region where the pair of reflective films overlap each other as viewed in the plan view.
